(19) United States
(12) Patent Application Publication
(10) Pub. No.: US 2025/0242513 A1
(43) Pub. Date: Jul. 31, 2025

(54) ROTARY KNIFE DEFLECTOR FOR DIRECTING TRIMMINGS

(71) Applicant: Hantover, Inc., Overland Park, KS (US)

(72) Inventors: Ronald J. Curnett, Cross Timbers, MO (US); Hilary Lynne Huff Philgreen, Leawood, KS (US)

(73) Assignee: Hantover, Inc., Overland Park, KS (US)

(21) Appl. No.: 19/037,000

(22) Filed: Jan. 24, 2025

Related U.S. Application Data
(60) Provisional application No. 63/625,718, filed on Jan. 26, 2024.

(51) Int. Cl. B26D 7/18; B25F 5/00; B26B 25/00; B26B 29/02

(52) U.S. Cl. CPC B26D 7/18; B25F 5/003; B26B 25/00; B26B 29/02; B26D 2210/02

(57) ABSTRACT

The rotary knife for cutting trimmings from a material includes a frame, a blade housing, an annular blade, and a trimming deflection element. The annular blade is rotatably supported on the blade housing for rotation about a rotational axis. The annular blade defines an outer circumferential margin. The trimming deflection element is coupled to the frame. The trimming deflection element extends radially from a location within the outer circumferential margin of the annular blade to at least the outer circumferential margin, such that the trimming deflection element is configured to direct trimmings radially outward relative to the rotational axis.

### CROSS REFERENCE TO RELATED APPLICATIONS

This application claims priority benefit of U.S. Provisional Patent Application No. 63/625,718 filed Jan. 26, 2024, and titled ROTARY KNIFE MATERIAL DEFLECTOR FOR DIRECTING TRIMMINGS AWAY FROM CARCASS. The foregoing application is hereby incorporated by reference in its entirety.

### FIELD OF THE DISCLOSURE

The present invention relates generally to powered knives, such as those commonly used in meat processing plants. More specifically, embodiments of the present invention concern a rotary knife having a material deflector for directing trimmings away from the knife blade.

### BACKGROUND

Powered rotary knives that are used in the meat processing industry for dressing an animal carcass are known in the art. The process of dressing the carcass normally involves the removal of meat and fat from various bones as well as cutting various bones. Powered rotary knives enable workers to perform this process with great efficiency. However, such trimming operations are not only labor intensive, but also require a human assessment of where to remove the fat and how much to remove. Furthermore, a human is typically required to remove trimmings from the knife blade and/or the carcass. In addition, carcass material may jam up the rotating blade, causing overheating, vibrations, and generally inconsistent cutting/trimming operations.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a rotary knife is provided. The rotary knife is operable to cut trimmings from a material (such as a body of meat, animal carcass, inanimate objects, etc.). The rotary knife includes a frame, a blade housing, an annular blade, and trimming deflection element coupled to the frame. The annular blade is rotatably supported on the blade housing for rotation about a rotational axis. The annular blade defines an outer circumferential margin. The trimming deflection element extends radially from a location within the outer circumferential margin of the annular blade to at least the outer circumferential margin, such that the trimming deflection element is configured to direct trimmings radially outward relative to the rotational axis.

In another aspect, a trimming deflector for a rotary knife, wherein the rotary knife includes a frame, an annular blade supported on the frame for rotation about a rotational axis, and the blade presents a radially outer circumferential margin and includes a cutting edge at an axial end of the blade. The trimming deflector includes a deflector mount configured for attachment to the frame and a trimming deflection element projecting from the deflector mount. The deflector mount is sized and dimensioned to extend from the frame to a position within the outer circumferential margin of the annular blade, when the deflector mount is attached to the frame. Furthermore, the trimming deflection element is configured to extend radially from the position to at least the outer circumferential margin of the annular blade, when the deflector mount is attached to the frame, such that the trimming deflection element is configured to direct trimmings radially outward relative to the rotational axis.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWING FIGURES

The drawing figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is an upper perspective of a rotary knife constructed in accordance with an embodiment of the present invention, with the rotary knife including a depth gauge assembly and a material deflection element;

FIG. 2 is an upper perspective of the rotary knife of FIG. 1, rotated approximately one hundred and eighty degrees) (180° relative to the view depicted in FIG. 1;

FIG. 3 is a top view of the rotary knife of FIGS. 1 and 2;

FIG. 4 is a partial section view of the rotary knife of FIG. 3, taken about line 4-4, the depth gauge assembly shown in a raised position;

FIG. 5 is an upper perspective of view of the partial section of the rotary knife, the depth gauge assembly shown in a lowered position;

FIG. 6 is a side view of the partial section view of the rotary knife similar to FIG. 4, but illustrating the depth gauge assembly in the lowered position;

FIG. 7 is an exploded perspective of the depth gauge assembly, taken from a rearward angle;

FIG. 8 is an exploded perspective of the depth gauge assembly, taken from a forward angle;

FIG. 9 is sectional view of a gauge body and a support of the depth gauge assembly, taken about a center plane of the gauge body;

FIG. 10 is an upper perspective of an alternative rotary knife constructed in accordance with an embodiment of the present invention, with the rotary knife including an alternative depth gauge assembly and material deflector;

FIG. 11 is a side view of the alternative rotary knife of FIG. 10; and

FIG. 12 is a top view of the alternative rotary knife of FIGS. 10 and 11.

Unless otherwise indicated, the drawing figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein. While the drawings do not necessarily provide exact dimensions or tolerances for the illustrated components or structures, the drawings are to scale with respect to the relationships between the components of the structures illustrated in the drawings.

### DETAILED DESCRIPTION

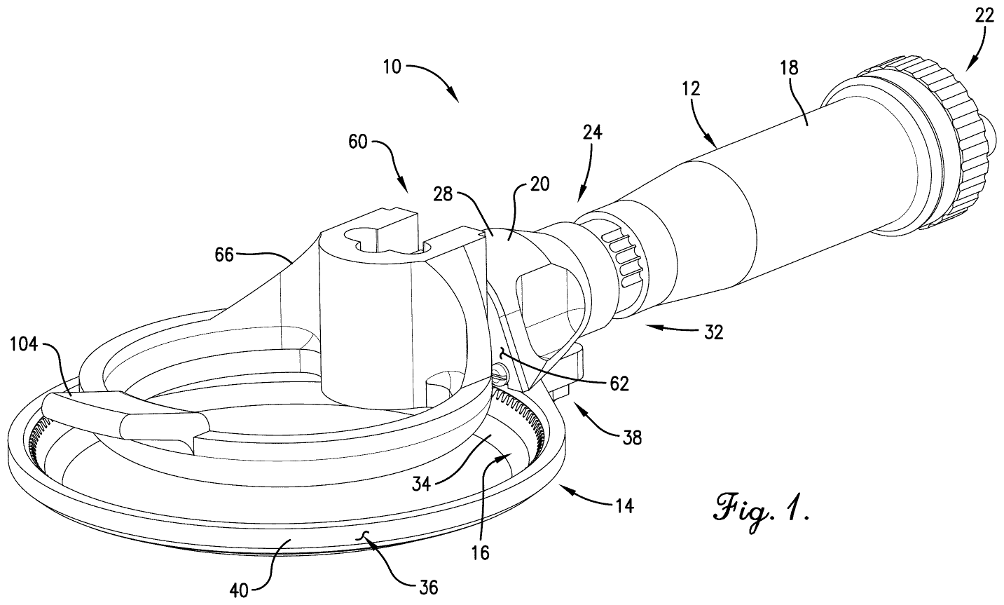

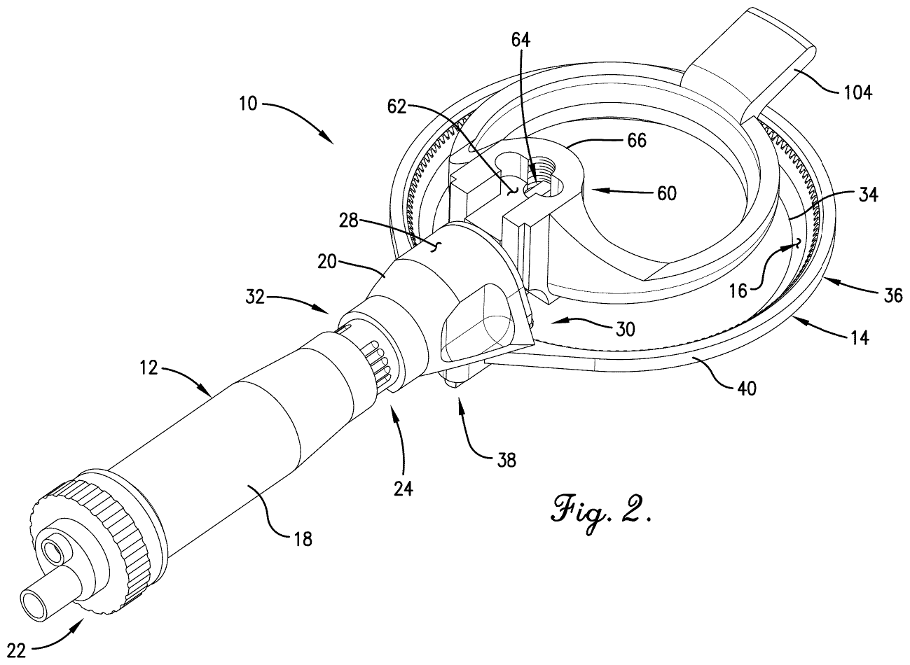

Turning initially to FIGS. 1-4, a rotary knife 10 is constructed in accordance with a preferred embodiment of the present invention. The illustrated rotary knife 10 is particularly well suited for use in meat processing facilities, although other knife applications are entirely within the ambit of the present invention. The illustrated rotary knife 10 is preferably pneumatically powered by a pressurized air source (not shown), such as an air compressor. However, the principles of the present invention are equally applicable where the rotary knife 10 is driven by alternative external power sources, such as sources that transmit power through hydraulic power or electrical power. The rotary knife 10 broadly includes a frame 12, a blade carrier assembly 14, and a rotating blade assembly 16.

The frame 12 preferably includes a grip housing 18 and a base 20. The grip housing 18 has a generally cylindrical shape and extends between a proximal connector end 22 for interfacing with a pneumatic supply line (not shown) and a distal end 24. The grip housing 18 further presents an internal passage (not shown) that houses a driving element, such as a pneumatic motor (not shown). The frame 12 is depicted in the drawings as a handle configured for human grasping; however, it is consistent with the principles of the present invention for the frame 12 to include other configurations, such as various handle designs, or attachments to facilitate automated function (e.g., where the frame has no handle but rather is configured for direct connection to a robotic arm).

Various means for attaching the base 20 to the grip housing 18 are known to those skilled in the art. For example, U.S. Pat. No. 8,893,391, issued Nov. 25, 2014, entitled ROTARY KNIFE WITH MECHANISM FOR CONTROLLING BLADE HOUSING, discloses such a means and is hereby incorporated in its entirety by reference herein. Suffice it to explain that the base 20 is attached to the grip housing 18 through the use of a threaded sleeve and bushing (not shown). In particular, the bushing is slidably received on the sleeve. The sleeve is threaded into the distal end 24 of the grip housing 18 and the proximal end 32 of the base 20. Thus, the grip housing 18, base 20, and sleeve cooperatively present a chamber to receive a motor and drive train (not shown) operable to drive the spur gear.

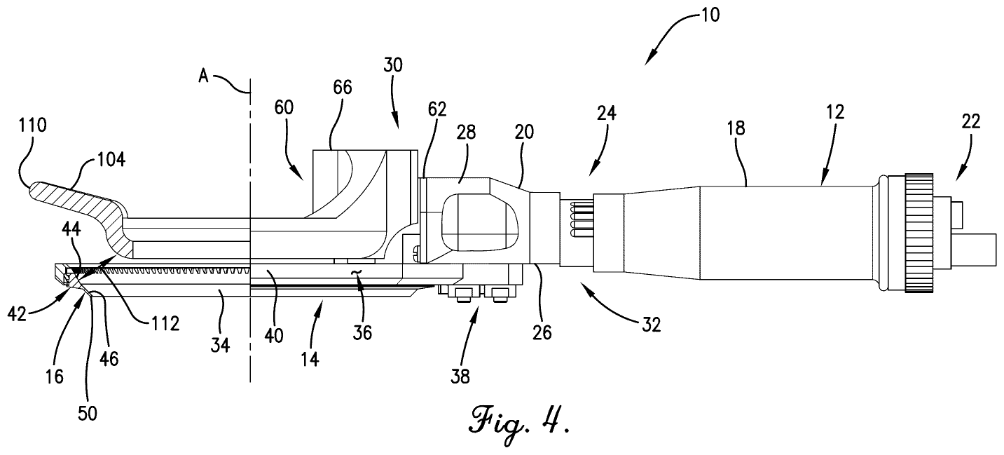

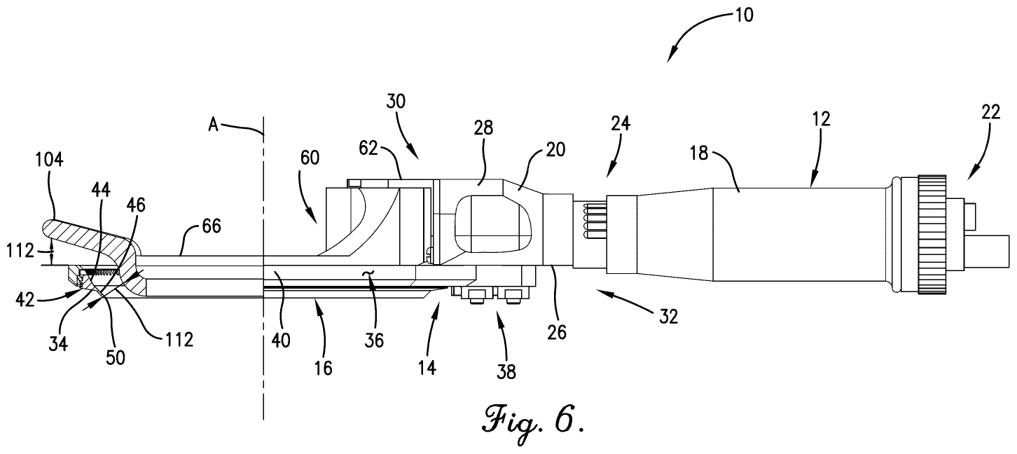

The base 20 includes a body with a generally flat wall 26 (see FIGS. 4 and 6) and a curved wall 28 that extend between distal and proximal ends 30, 32, respectively, of the base 20. The body presents a gear-receiving socket (not shown) that extends distally from the proximal end 32. The socket is sized to receive a spur gear or pinion (not shown) and to permit rotation thereof. The spur gear is interconnected with and is driven by the pneumatic motor.

In the example, the blade carrier assembly 14 rotatably supports an annular blade 34 during knife operation. In the illustrated embodiment, the blade carrier assembly 14 generally includes an expandable blade housing 36 and a blade housing expansion assembly 38. The illustrated expansion assembly 38 is configured to attach the blade housing 36 to the base 20, for example, at the flat wall 26, and facilitate controlled movement of the blade housing 36 between a blade-securing condition (shown in FIGS. 1-6) and a blade-releasing condition (not shown). It will be appreciated, however, that the principles of the present invention are equally applicable to alternative blade carrier assemblies and means for securing the blade housing 36 to the frame 12.

The illustrated blade housing 36 is substantially unitary and annular. The blade housing 36 includes an annular ring that extends continuously between adjacent (but separate) housing ends. The annular ring includes an arcuate outer surface and an arcuate inner surface (not shown). The arcuate outer surface defines an outer circumferential margin 40. The inner surface presents a groove that serves as a race for rotatably supporting the blade assembly 16. The groove extends along the perimeter of the blade housing between the ends. Thus, the blade housing 36 presents a socket that receives the annular blade 34.

While the illustrated blade housing 36 includes a single groove, it is consistent with the principles of the present invention for the blade housing 36 to alternatively include multiple grooves for engagement with the blade assembly 16. Moreover, it is also within the ambit of the present invention for the groove to include alternative shapes or surface features. Additional details of a rotary knife with such alternative groove structures are disclosed in U.S. Pat. No. 8,037,611, issued Oct. 18, 2011, entitled ROTARY KNIFE WITH BLADE BUSHING, which is hereby incorporated in its entirety by reference herein.

The blade housing 36, as well as the frame 12, are preferably manufactured from a tempered steel to resist oxidation and corrosion within the adverse environment of a slaughterhouse. However, the principles of the present invention are equally applicable where the blade housing 36 and frame 12 include other metallic or non-metallic materials such as brass, composite, aluminum, or stainless steel. The blade housing 36, either entirely or partly, may alternatively include an outermost layer of brass, composite, aluminum, or stainless steel that is suitable for surface-to-surface engagement with the blade assembly 16. In this manner, such an outermost layer, whether coated, adhered, or otherwise secured onto the base material, may provide an optimal surface for low-friction bearing engagement with the blade assembly 16. However, the outermost layer may be included for other purposes, such as corrosion resistance, aesthetic qualities, or other performance requirements.

The blade housing 36 is preferably attached to the base 20 by any suitable means. In the illustrated embodiment, the expansion assembly 38 serves to adjustably support the blade housing 36 on the base 20, and more particularly, the flat wall 26. In this manner, the grip housing 18 extends longitudinally away from the blade housing 36. That is, the blade housing 36 extends in a first direction from the base 20 and the grip housing 18 extends in a second direction opposite the first direction from the base 20. It is noted that the expansion assembly 38 is described in the above-incorporated '391 patent and is well understood by those skilled in the art.

In some embodiments, the blade carrier assembly 14 may also include an annular bushing interposed between the blade 34 and the housing 36. In the example embodiment, the illustrated blade 34 is unitary (with an integrated housing-engaging race) and is substantially continuous around its circumference, presenting a diameter.

Referring to FIGS. 4-6, the annular blade 34 may include a blade wall 42. The blade wall 42 includes a support section 44. An inner blade surface 46 of the wall 42 terminates in a cutting edge 50. The cutting edge 50 presents a planar bottom surface of the annular blade 34. The blade wall 42 is substantially circular, defining a rotational axis “A,” when the annular blade 34 is mounted to the rotary knife 10. As such, the cutting edge 50 defines an inner circular hole of the annular blade 34.

The support section 44 includes an outer blade race defining an outer circumferential margin 48. The blade race may include a substantially rectangular cross-section. It is consistent with the principles of the present invention for the blade race to include any other alternative cross-sectional profile, such as arcuate, semi-circular, trapezoidal, etc. In the example embodiment, the blade race has a cross-sectional profile that is complementary of the cross-sectional profile of the groove of the blade housing 36, thereby allowing the annular blade 34 to be rotatably supported on the blade housing 36 for rotation about the rotational axis “A.” Notably, because the blade housing 36 supports the annular blade in this manner, the blade housing outer circumferential margin 40 is spaced radially outward from the outer circumferential margin 48 of the annular blade 34.

The annular blade 34 is preferably manufactured from tempered steel. However, similar to the blade housing 36 and frame 12, the principles of the present invention are applicable where the blade 34 includes other metallic or non-metallic materials, such as brass, composite, aluminum, or stainless steel. Alternatively, the blade 34, either entirely or partly, may include an outermost layer of brass, aluminum, or stainless steel that is suitable for surface-to-surface engagement with the blade housing 36. In this manner, such an outermost layer, whether coated, adhered, or otherwise secured onto the base material, may provide an optimal surface for low-friction bearing engagement. However, the outermost layer may be included for other purposes, such as corrosion resistance, aesthetic qualities, or other performance requirements.

Turning to FIGS. 1-6, the rotary knife 10 preferably includes a depth gauge 60. The depth gauge 60 includes a support 62 removably attached to the distal end 30 of the base 20, with the support 62 being in a generally covering relationship with the socket (and overlying the pinion gear for driving rotation of the blade). The preferred depth gauge 60 also includes an adjustment mechanism 64 and a gauge body 66.

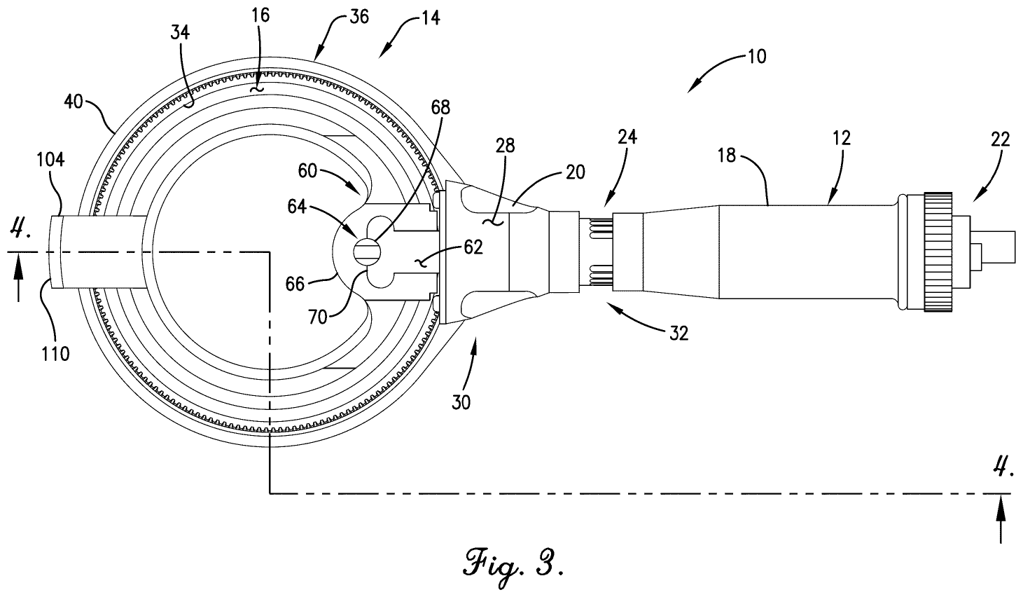

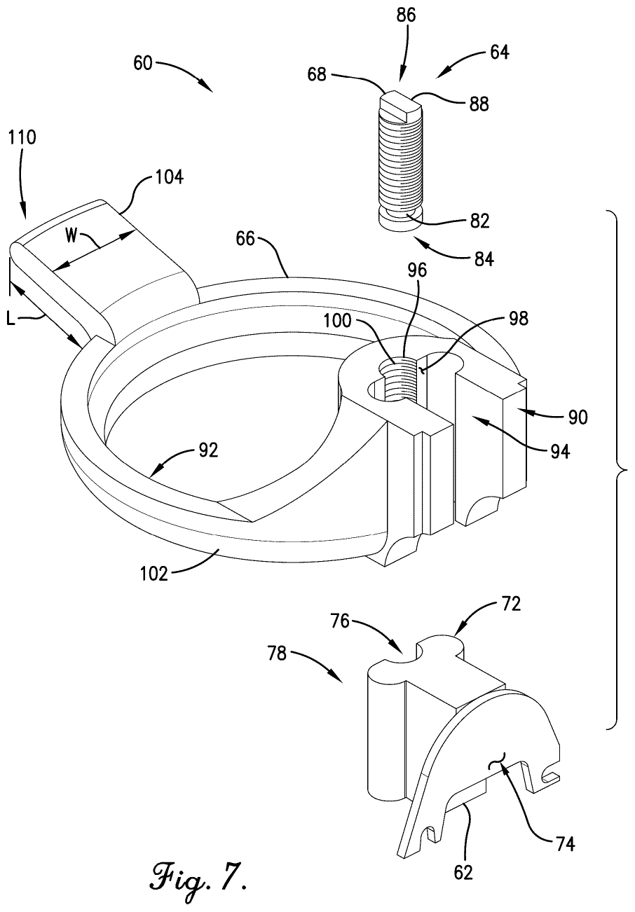

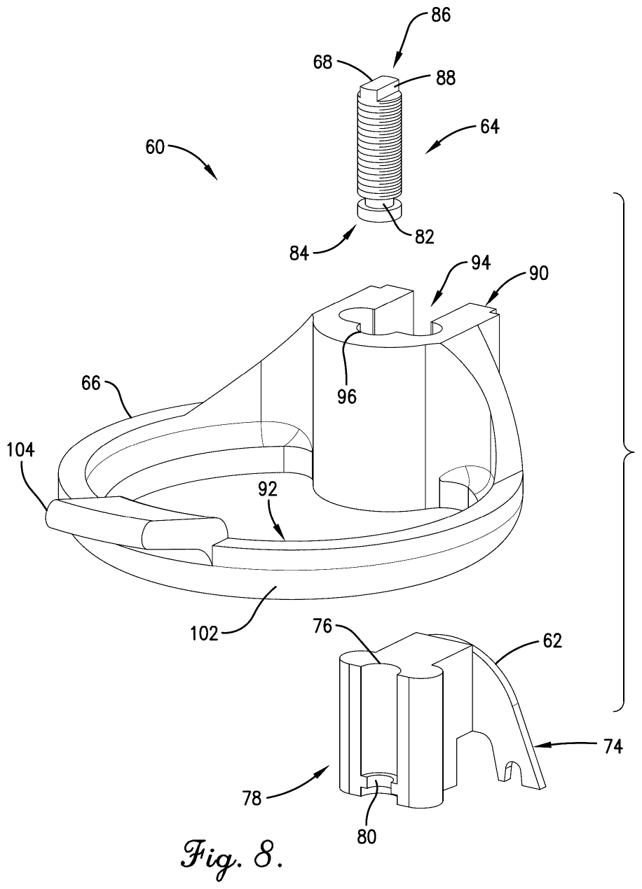

Referring to FIGS. 7 and 8, in the example, the adjustment mechanism 64 includes an adjustment screw 68 that is rotatably connected to each of the support 62 and the gauge body 66. As shown in FIG. 3, the adjustment screw 68 is centered on an interface 70 between the support 62 and the gauge body 66. The support 62 and the gauge body 66 are configured to fit slidingly together or otherwise be shiftably interconnected. In the illustrated embodiment, the support 62 and gauge body 55 define a sliding joint that permits relative shifting along the rotational axis “A,” as depicted in FIG. 4. Specifically, the support 62 is fixed to the base 20, and the gauge body 66 is adjustable along the rotational axis “A” relative to the base 20 and support 62.

The support 62 includes a generally T-shaped portion 72 that extends axially along the rotational axis “A” when attached to the body 20. The T-shaped portion 72 is integrally attached to a cover portion 74. The cover portion 74 is removably attached to the distal end 30 of the base 20, with the cover portion 74 being in a generally covering relationship with the socket, as described above. The T-shaped portion 72 includes a semi-circular groove 76 defined in a distal end 78 of the T-shaped portion 72, opposite the cover portion 74. The groove 76 extends along the rotational axis “A” when attached to the body 20. The arms of the T-shaped portion 72 are full radiuses, presenting a generally semi-circular, convex portion. At a lower end of the groove 76, a lip 80 extends generally radially inward from a face of the groove 76. The groove 76 is preferably smooth (unthreaded). The lip 80 is sized and shaped to facilitate retaining the adjustment screw 68, as will be discussed further below. The support 62 may be fabricated from stainless steel via machining, for example, although other materials and methods of fabrication are within the ambit of the present invention.

The adjustment screw 68 is generally fabricated from threaded stock material. A groove 82 is cut into the threaded stock material proximate a first end 84 of the adjustment screw 68. At the second end 86 opposite the groove 82, the adjustment screw 68 has a narrow, rectangular head 88 defined thereon. The rectangular head 88 is sized and shaped to fit into a tool (not shown) that has a notch or groove defined therein. In alternative embodiments, the head 88 end of the adjustment screw 68 may be defined by an axially extending rod configured to work with robotic equipment (not shown). As such, the axially extending rod may present generally cylindrical elements that the robotic equipment may easily grasp (or be otherwise suitably fastened or coupled to) and turn. In the exemplary embodiment, the adjustment screw 68 may be fabricated from stainless steel threaded rod via machining, although other materials and methods of fabrication are within the ambit of the present invention.

In the example embodiment, the gauge body 66 includes a base portion 90 and a generally circular portion 92 extending therefrom. In the exemplary embodiment, the circular portion 92 is ring-shaped. It is noted, however, that in some embodiments, the circular portion 92 need not be annular. Rather, the circular portion 92 may be disk-shaped, without an aperture defined therethrough.

In the example embodiment, the base portion 90 has a height that is about three (3) times a height of the circular portion 92. The base portion 90 includes a T-shaped groove 94 defined therein, which is sized and shaped to conform to the T-shaped portion 72 of the support 62. As discussed herein, the T-shaped groove 94 inter-engages with the T-shaped portion 72 to define a sliding joint in one direction, while securely preventing movement of the gauge body 66 in the two (2) other directions. Like the support 62, the gauge body 66 includes a semicircular groove 96 defined in a face 98 of the T-shaped groove 94. The groove 96 cooperates with the groove 76 of the support 62 to define a cylindrical aperture. Contrary to the smooth surface of the groove 76, the groove 96 of the gauge body 66 includes threads 100 defined therein, wherein the threads are sized and shaped to threadedly engage the adjustment screw 68.

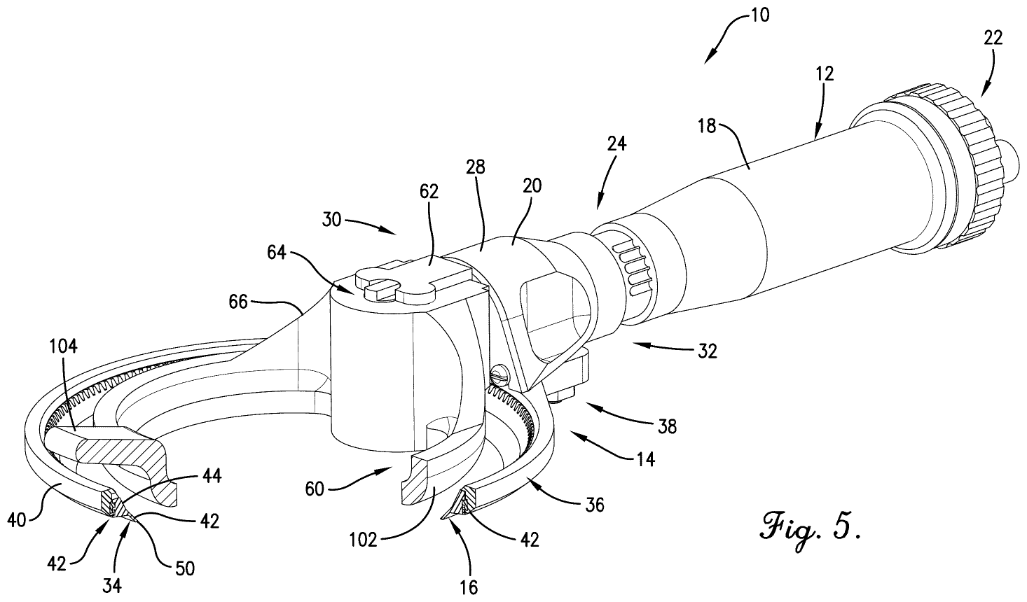

Referring to FIG. 5, the circular portion 92 has a generally arcuate cross-sectional shape. The gauge body 66 presents a generally smooth, body-engaging surface 102 adjacent the cutting edge 50 of the annular blade 34. The body-engaging surface 102 is configured to engage the material being cut as the annular blade 34 cuts trimmings therefrom. Furthermore, as depicted in FIGS. 1-6, the body-engaging surface 102 of the gauge body 66 is spaced radially inwardly from the cutting edge 50 of the annular blade 34. In most (if not all) positions of the gauge body, the body-engaging surface 102 is also spaced axially from the cutting edge 50. Furthermore, in the exemplary embodiment, the body-engaging surface 102 is annular and presents an inner circular opening that is concentric with the inner circular hole of the cutting edge 50.

The gauge body 66 may be fabricated from a high performance resin, such as a semi-crystalline thermoplastic polyester based on polyethylene terephthalate (PET-P) sold under the trademark ErtalyteR. It is noted, however, that the gauge body 66 may be fabricated from other suitable materials, include for example, resins, metals, ceramics, and the like.

In the example embodiment, the gauge body 66 includes a trimming deflection element (or deflector) 104. In this manner, the depth gauge 60 serves as a deflector mount. Certain aspects of the present invention, however, contemplate the use of other deflector mounts, particularly deflector mounts that do not function as a depth gauge.

The deflection element 104 extends from an edge of the annular portion 92. More particularly, the deflection element 104 extends from an edge of the annular portion 92 diametrically opposite the base portion 90. The deflection element 104 is configured to intercept trimmings from materials being cut, such as fat or tissue from animal carcasses, thereby reducing or eliminating the likelihood that such trimmings will curl back onto the workings of the rotary knife 10, such as the annular blade 34, blade housing 36, and/or the area where the spur gear meshes with the annular blade 34. In accordance with aspects of the present invention, the deflection element 104 may alternately be coupled to or extend from the frame 12 or some portion of the rotary knife 10 other than the circular portion 92 of the gauge body 66. The deflection element 104 may work cooperatively with the circular portion 92 of the gauge body 66 to deflect trimmings away from the rotary knife 10.

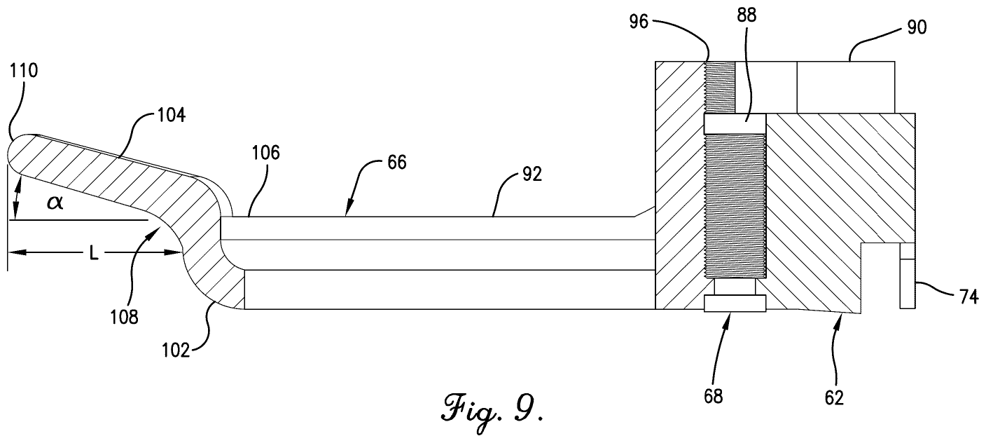

In the example embodiment, the deflection element 104 is formed integrally with the gauge body 66. As depicted in FIG. 9, the deflection element 104 extends from an upper edge 106 of the circular portion 92 at an upward angle a. In an embodiment, the angle a is in a range between and including about ten degrees) (10° and about twenty degrees) (20° relative to a bottom planar surface of the gauge body 66 (or the parallel planar bottom surface of the annular blade 34). In a preferred embodiment, the angle a is about sixteen degrees) (16°. The deflection element 104 joins the circular portion 92 at a generally arcuate interface 108. The arcuate interface 108 facilitates smoothly transitioning the trimmings away from the rotary knife 10. The body-engaging surface 102 and the arcuate interface 108 between the deflection element 104 and the circular portion 92, in combination with the angle a of the deflection element 104 provides a smooth passage for directing the trimmings away from the rotary knife 10.

In the example embodiment, the deflection element 104 is generally centered along a central longitudinal axis of the rotary knife 10 (generally defined by the frame 12). Referring to FIG. 9, the depicted deflection element 104 has a length “L” measured in the radial direction. The illustrated deflection element 104 extends to a distal element margin 110. Referring to FIG. 7, the depicted deflection element 104 has a transverse width dimension “W” that is equal to a value that is in a range between and including about ten percent (10%) and about fifty percent (50%) of the diameter of the annular blade 34.

Referring back to FIGS. 7 and 8, the adjustment mechanism 64 may also include the groove 76 of the support 62 and the threaded groove 96 of the gauge body 66, in addition to the adjustment screw 68. As such, the adjustment mechanism 64 is operable to selectively shift the gauge body 66 relative to the support 62. For example, the adjustment screw 68 threadedly engages the gauge body 66 so that rotation of the adjustment screw effects shifting of the gauge body 66 (along the axis of the screw) relative to the support 62. Further, the lip 80 (associated with the groove 76) extends into the groove 82 of the adjustment screw 68 so as to axially retain the screw 68 as the screw 82 is rotated.

Referring back to FIGS. 1-6, in operation, the gauge body 66 of the depth gauge 60 is adjustable along the rotational axis “A” relative to the blade 34. For example, the adjustment screw 68 of the adjustment mechanism 64 may be rotated, which causes the threads of the screw to engage with the threads 100 of the gauge body 66. Rotation of the adjustment screw 68 thereby shifts the gauge body 66 along the rotational axis “A” relative to the annular blade 34 and blade housing 36. The axial position of the trimming deflection element 104 relative to the cutting edge 50 of the annular blade 34 is thereby adjustable. Furthermore, as described above, the trimming deflection element 104 extends axially upward in a direction away from the cutting edge 50.

A spacing defined between the cutting edge 50 of the annular blade 34 and the body-engaging surface 102 of the gauge body 66 defines a thickness of the trimmings or a cutting depth of the annular blade 34. As described herein, the gauge body 66 is shiftably supported on the frame 12 so that the axial spacing of body-engaging surface 102 relative to the cutting edge 50 is adjustable. Adjustment of the axial spacing also serves to adjust the spacing between the near most points of the body-engaging surface 102 and cutting edge 50, with such spacing generally defining the maximum cutting dimension of the knife. As such, the gauge body 66 is configured to control the cutting depth of the annular blade 34. In other embodiments, the gauge body 66 may be coupled to the frame 12 such that it is not axially adjustable, whereby the cutting depth control is a fixed dimension.

In the example embodiment, the trimmings pass through this space as they are trimmed or cut from the material (e.g., carcass), where they engage the deflection element 104 and are directed away from the rotary knife 10 (more particularly, away from the rotational axis “A”). In an example, the trimming deflection element 104 extends in a direction opposite the longitudinal extension of the grip housing 18 relative to the blade housing 36. As such, as the rotary knife is pulled along the material to cut trimmings therefrom, the trimmings are directed away from the rotary knife 10 and deflected by the deflection element 104 diametrically opposite the grip housing 18.

Notably, the shape and orientation of the deflection element 104 is defined such that the spacing between a lower surface of the deflection element 104 and an upper surface of the blade housing 36 is at least as large as the spacing between the cutting edge 50 of the annular blade 34 and body-engaging surface 102 in all positions of the gauge body 66. This ensures that there is no pinch point along the path to prevent or impede smooth passage of the trimmings.

Because the support 62 is fixed to the base 20 and the adjustment screw 68 is rotatable but axially fixed to the support 62, only the gauge body 66 shifts axially relative to the rotational axis “A” during rotation of the adjustment screw 68. The axial shifting of the gauge body 66 allows a user to adjust a gap 112 (see FIGS. 4 and 6, depicting raised and lowered positions, respectively, of the gauge body 66) defined between the annular blade 34 and the gauge body 66. The gap 112 essentially limits the thickness of trimmings that can be cut or trimmed away during a cutting operation with the rotary knife 10.

In the example embodiment, the trimming deflection element 104 extends radially from a location within the outer circumferential margin 48 of the annular blade 34 to at least the outer circumferential margin 48, such that the trimming deflection element 104 is configured to direct trimmings radially outward relative to the rotational axis “A.” In a preferred embodiment, the trimming deflection element 104 projects radially beyond the outer circumferential margin 48 of the annular blade 34. In one example, the trimming deflection element 104 extends radially beyond the outer circumferential margin 48 of the annular blade 34 to the distal element margin 110 (which is most preferably spaced outwardly relative to the blade 34 and blade housing 36). In the exemplary embodiment, the distal element margin 110 is spaced from the outer circumferential margin 48 a distance between and including about five percent (5%) and about fifteen percent (15%) of the diameter of the circumferential margin 48 of the annular blade 34.

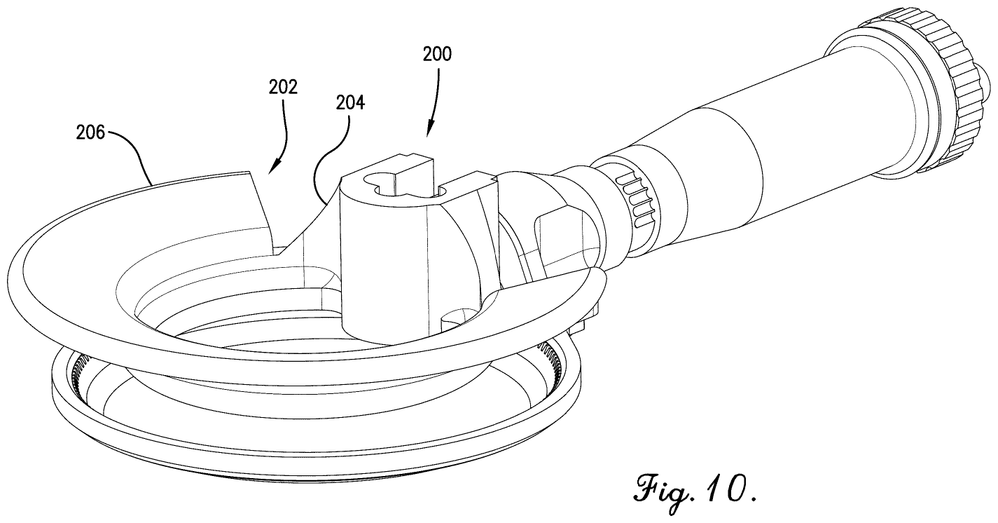

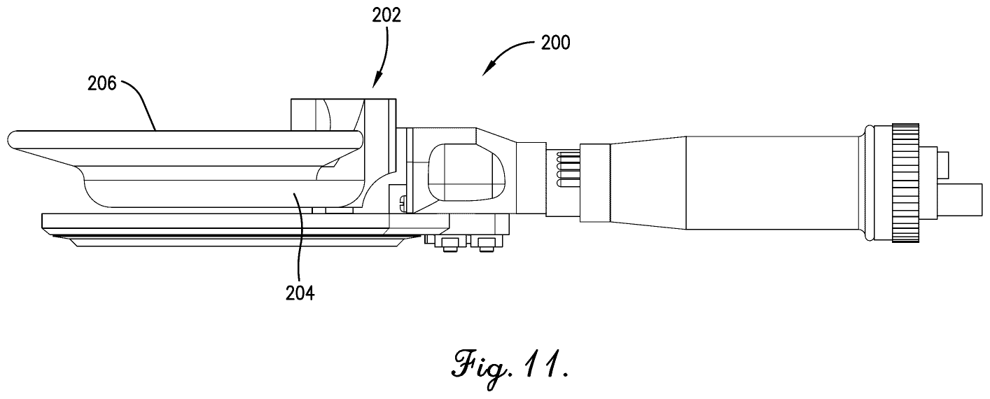

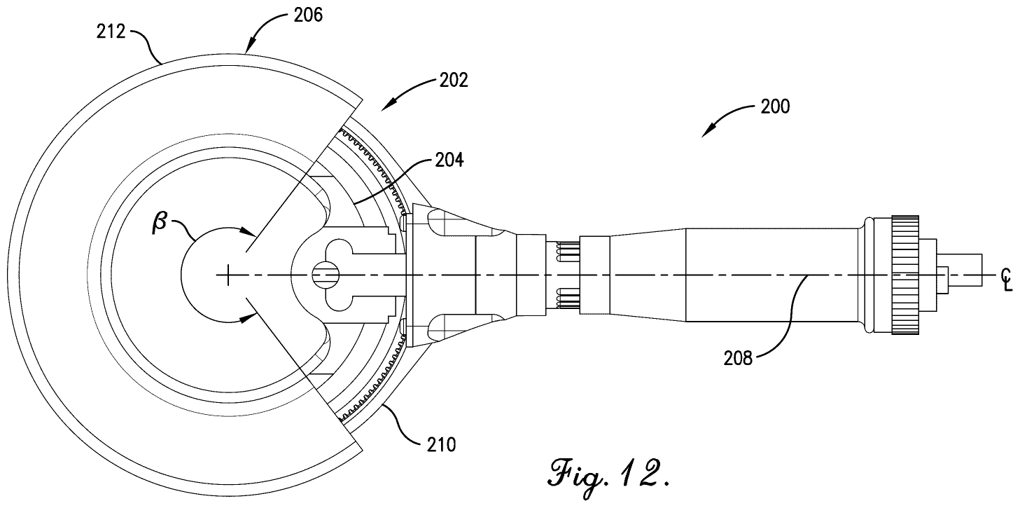

FIGS. 10-12 depict an alternative rotary knife 200 having a depth gauge 202. In the example embodiment, the rotary knife 200 is substantially the same as the rotary knife 10 described in FIGS. 1-6. As with the depth gauge 60 described above, the depth gauge 202 includes a gauge body 204 having a deflection element 206. (As with the embodiment depicted in FIGS. 1-6, the deflection element 206 may be supported relative to the frame by suitable structure other than the depth gauge. That is, depth gauge 202 may be eliminated altogether and the knife may have an alternative support or framework for appropriately supporting the deflection element 206 in the desired location relative to the blade.) In the example, the deflection element 206 may extend less or more circumferentially around a portion of the blade housing 210, wherein a distal edge 212 of the deflection element 206 defines an outer radius. For example, in the present embodiment, the deflection element 206 may extend circumferentially at an angle 8 in a range between and including of about twenty degrees) (20° to about two hundred and fifty-five degrees) (255°. The distal edge 212 of the deflection element 206 may extend outward beyond an outer edge of the blade housing 210 an amount equal to that disclosed herein with respect to the deflection element 104. As such, the deflection element 206 may engage with the trimmings along a path that clearly directs the trimmings away from the rotary knife 200. The deflection element 206 also serves to deflect trimmings along a greater portion of the circumference of the blade than the deflection element 104. While the deflection element 104 is designed to deflect trimmings cut by the relatively small portion of the blade spaced furthest from the frame 12, the deflection element 206 is operable to deflect trimmings cut by a major portion (more than one hundred eighty degrees) (180° and, more preferably, up to two hundred and fifty-five degrees)) (255° of the blade. In other words, the deflection element 206 deflects trimmings when cut by either side of the blade, as well as the distal end of the blade.

The deflection elements described herein, such as the deflection elements 104 and 206, function to deflect a cut or trimmed material away from a rotary knife. This results in increased performance of the rotary knife and/or cutting operation. Some trimmings may have a tendency to curl when being cut, which typically involves curling of the material back (radially inward) toward the rotary knife and/or the operator of the knife. The curled material may hinder the cutting or trimming operation and/or jam or get stuck around the interface between the pinion and annular blade. This may result in overheating the rotary knife, burning the carcass and/or trimmings, causing vibrations of the blade, and other general performance degradations of the rotary knife and/or cutting operation. Furthermore, in operations wherein the rotary knife may be employed with robotic equipment, the curled material may interfere with one or more sensors used to perform the cutting operation, thereby preventing the operation from being completed.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A rotary knife for cutting trimmings from a material, the rotary knife comprising:
a frame;
a blade housing;
an annular blade rotatably supported on the blade housing for rotation about a rotational axis, the annular blade defining an outer circumferential margin; and
a trimming deflection element coupled to the frame,
the trimming deflection element extending radially from a location within the outer circumferential margin of the annular blade to at least the outer circumferential margin, such that the trimming deflection element is configured to direct trimmings radially outward relative to the rotational axis.

2. The rotary knife in accordance with claim 1,
the annular blade presenting an annular inner blade surface that terminates at a cutting edge,
the trimming deflection element being spaced axially from the cutting edge.

3. The rotary knife in accordance with claim 2,
the trimming deflection element extending axially in a direction away from the cutting edge.

4. The rotary knife in accordance with claim 3,
the trimming deflection element projecting radially beyond the outer circumferential margin of the annular blade.

5. The rotary knife in accordance with claim 3,
the cutting edge presenting a planar bottom surface of the annular blade,
the trimming deflection element extending upward at an angle of about sixteen degrees) (16° relative to the bottom surface of the annular blade.

6. The rotary knife in accordance with claim 1,
the annular blade presenting a diameter,
the trimming deflection element presenting a length measured in the radial direction and a transverse width, the width being between about ten percent (10%) and about fifty percent (50%) of the diameter of the annular blade.

7. The rotary knife in accordance with claim 1,
the trimming deflection element extending radially beyond the outer circumferential margin of the annular blade to a distal element margin.

8. The rotary knife in accordance with claim 7,
the distal element margin being spaced from the outer circumferential margin a distance between about five percent (5%) and about fifteen percent (15%) of the diameter of the annular blade.

9. The rotary knife in accordance with claim 1,
the blade housing defining an outer circumferential margin that is spaced radially outward from the outer circumferential margin of the annular blade,
the trimming deflection element extending radially beyond the outer circumferential margin of the blade housing.

10. The rotary knife in accordance with claim 1,
the frame including a handle that extends longitudinally away from the blade housing,
the trimming deflection element extending in a direction opposite the longitudinal extension of the handle relative to the blade housing.

11. The rotary knife in accordance with claim 1,
the trimming deflection element extending arcuately relative to the rotational axis about an arc angle in a range between and including of about twenty degrees) (20° to about two-hundred and fifty-five degrees) (255°.

12. The rotary knife in accordance with claim 1, further comprising:
a depth gauge including a gauge body configured to control the cutting depth of the annular blade,
the gauge body including a body-engaging surface configured to engage the material as the annular blade cuts trimmings,
the trimming deflection element being integral with the gauge body.

13. The rotary knife in accordance with claim 12,
the annular blade presenting an annular inner blade surface that terminates at a cutting edge,
the body-engaging surface of the gauge body being spaced axially and radially inwardly from the cutting edge.

14. The rotary knife in accordance with claim 13,
the cutting edge defining an inner circular hole,
the body-engaging surface being annular and presenting an inner circular opening that is concentric with the inner circular hole of the cutting edge.

15. The rotary knife in accordance with claim 14,
the depth gauge being adjustable to vary the cutting depth of the annular blade,
the gauge body being shiftably supported on the frame so that the axial spacing of body-engaging surface relative to the cutting edge is adjustable.

16. The rotary knife in accordance with claim 15,
the depth gauge including a support fixed to the frame,
the gauge body being supported on the frame by the support,
the gauge body and support being shiftably interconnected.

17. The rotary knife in accordance with claim 16,
the depth gauge including an adjustment mechanism operable to selectively shift the gauge body relative to the support,
the adjustment mechanism comprising a threaded adjustment screw threadedly engaging the gauge body so that rotation of the adjustment screw effects shifting of the gauge body relative to the support.

18. A trimming deflector for a rotary knife, wherein the rotary knife includes a frame, an annular blade supported on the frame for rotation about a rotational axis, and the blade presents a radially outer circumferential margin and includes a cutting edge at an axial end of the blade, the trimming deflector comprising:
a deflector mount configured for attachment to the frame,
the deflector mount being sized and dimensioned to extend from the frame to a position within the outer circumferential margin of the annular blade, when the deflector mount is attached to the frame; and
a trimming deflection element projecting from the deflector mount,
the trimming deflection element configured to extend radially from the position to at least the outer circumferential margin of the annular blade, when the deflector mount is attached to the frame, such that the trimming deflection element is configured to direct trimmings radially outward relative to the rotational axis.

19. The trimming deflector in accordance with claim 18,
the deflector mount including an annular body,
the trimming deflection element extending radially from the annular body.

20. The trimming deflector in accordance with claim 19,
the deflector mount including a support configured to be fixedly attached to the frame so as to support the annular body on the frame.

21. The trimming deflector in accordance with claim 20,
the support and annular body being shiftably interconnected so that the annular body is shiftable relative to the support.

22. The trimming deflector in accordance with claim 19,
the trimming deflection element being integral with the annular body,
the trimming deflection element and annular body being fabricated from a corrosion-resistant material selected from the group consisting of a stainless steel, an aluminum alloy, and a composite polymer.

23. The trimming deflector in accordance with claim 19,
the trimming deflection element extending arcuately along the annular body an arc angle in a range between and including of about twenty degrees) (20° to about two-hundred and fifty-five degrees) (255°.
